(19) United States
(12) Patent Application Publication
(10) Pub. No.: US 2015/0325834 A1
(43) Pub. Date: Nov. 12, 2015

(54) METHOD FOR MANUFACTURING ALL-SOLID-STATE BATTERY

(71) Applicant: Kazuhito KATO, Suntou-gun, Shizuoka-ken (JP)

(72) Inventor: Kazuhito KATO, Suntou-gun, Shizuoka-ken (JP)

(73) Assignee: TOYOTA JIDOSHA KABUSHIKI KAISHA, Toyota-shi, Aichi (JP)

(21) Appl. No.: 14/405,997

(22) PCT Filed: Jul. 11, 2012
(86) PCT No.: PCT/JP2012/067695

§ 371 Date: Dec. 5, 2014

(51) Int. Cl. H01M 4/04

(52) U.S. Cl. CPC H01M 4/043

(57) ABSTRACT

A main object of the present invention is to provide a method for manufacturing an all-solid-state battery capable of inhibiting a short circuit. The present invention is a method for manufacturing an all-solid-state battery including a cathode layer, an anode layer, and a solid electrolyte arranged between the cathode layer and the anode layer, the method including: a first pressing step of pressing the solid electrolyte layer at a first pressure before arranging the solid electrolyte layer between the cathode layer and the anode layer; and a second pressing step of pressing the solid electrolyte layer which has been pressed in the first pressing step and is arranged between the cathode layer and the anode layer, at a second pressure smaller than the first pressure.

### FIELD OF THE INVENTION

The present invention relates to a method for manufacturing an all-solid-state battery.

### DESCRIPTION OF THE RELATED ART

A lithium-ion secondary battery has a higher energy density and is operable at a high voltage compared to conventional secondary batteries. Therefore, it is used for information devices such as a cellular phone, as a secondary battery which can be easily reduced in size and weight, and nowadays there is also an increasing demand for the lithium-ion secondary battery to be used as a power source for large-scale apparatuses such as electric vehicles and hybrid vehicles.

The lithium-ion secondary battery includes a cathode layer, an anode layer, and an electrolyte layer arranged between them. An electrolyte to be used in the electrolyte layer is, for example, a non-aqueous liquid or a solid. When the liquid is used as the electrolyte (hereinafter, the liquid being referred to as “electrolytic solution”), it easily permeates into the cathode layer and the anode layer. Therefore, an interface can be formed easily between the electrolytic solution and active materials contained in the cathode layer and the anode layer, and the battery performance can be easily improved. However, since commonly used electrolytic solutions are flammable, it is necessary to have a system to ensure safety. On the other hand, if a nonflammable solid electrolyte (hereinafter referred to as “solid electrolyte”) is used, the above system can be simplified. As such, a lithium-ion secondary battery provided with a layer including a solid electrolyte has been suggested (hereinafter, the layer being referred to as “solid electrolyte layer” and the battery being referred to as “all-solid-state battery”).

As a technique related to the lithium-ion secondary battery, for example Patent Document 1 discloses a unit cell element wherein the sizes of a cathode layer, an electrolyte layer, and an anode layer are not identical with one another, and they are made such that the cathode layer<the anode layer<the electrolyte layer, in order to prevent a short circuit of the cathode layer and the anode layer.

### CITATION LIST

### Patent Literatures

Patent Document 1: Japanese Patent Application Laid-Open No. 2001-6741

### SUMMARY OF THE INVENTION

### Problems to be Solved by the Invention

Regarding the all-solid-state battery, for the purpose of reducing ion conductivity resistance and the like, sometimes a structure including a solid electrolyte layer is pressed in manufacturing the all-solid-state battery. If the technique disclosed in Patent Document 1 is applied to the all-solid-state battery including the solid electrolyte layer, for example an end portion of a cathode layer smaller than the solid electrolyte layer, and an end portion of the anode layer smaller than the solid electrolyte have contact with the periphery of the solid electrolyte layer. If the cathode layer smaller than the solid electrolyte layer and the solid electrolyte that have contact with each other are pressed, since the pressure concentrates to a portion of the periphery of the solid electrolyte layer where is in contact with the end portion of the cathode layer, the periphery of the solid electrolyte layer easily breaks to have cracks. Similarly, if the anode layer smaller than the solid electrolyte layer and the solid electrolyte layer that have contact with each other are pressed, since the pressure concentrates to a portion of the periphery of the solid electrolyte layer where is in contact with the end portion of the cathode layer, the periphery of the solid electrolyte layer easily breaks to have cracks. If the periphery of the solid electrolyte layer breaks as described above, there is a possibility that a cathode active material and an anode active material enter the broken portion to reach their opposite poles thereby creating a short circuit.

Accordingly, an object of the present invention is to provide a method for manufacturing an all-solid-state battery capable of preventing a short circuit.

### Means for Solving the Problems

If the solid electrolyte layer is thinly made for the purpose of improving the volume energy density and reducing the resistance, holes passing through the solid electrolyte layer in a thickness direction are easily formed, whereby a short circuit easily occurs. The inventor of the present invention carried out an intensive study regarding the technique to make the short circuit difficult to occur even if the solid electrolyte layer is thinly made. As a result of the study, the inventor has found out that a short circuit of the all-solid-state battery can be inhibited, even though holes are created in the solid electrolyte layer, by carrying out a pressing in the manufacturing process of the all-solid-state battery such that the holes are occluded. Also, in order to improve productivity, it is preferable that the all-solid-state battery is manufactured by means of processes having the same form, regardless of whether the sizes of the cathode layer and the anode layer are same as the size of the solid electrolyte layer or not. The inventor of the present invention has found out the following: the thickness of the solid electrolyte layer can be made thin; the break of the solid electrolyte layer can be inhibited; and even though the solid electrolyte layer has holes, the holes can be occluded by: pressing the solid electrolyte layer at a predetermined pressure (for example, a maximum pressing pressure in manufacturing processes) before arranging the solid electrolyte layer between the cathode layer and the anode layer; thereafter, arranging the solid electrolyte between the cathode layer and the anode layer, then pressing them. The present invention has been made based on the above findings.

In order to solve the above problems, the present invention takes the following means. Namely, the first aspect of the present invention is a method for manufacturing an all-solid-state battery including a cathode layer, an anode layer, and a solid electrolyte layer arranged between the cathode layer and the anode layer, the method including: a first pressing step of pressing the solid electrolyte layer at a first pressure before arranging the solid electrolyte layer between the cathode layer and the anode layer; and a second pressing step of pressing the solid electrolyte layer which has been pressed in the first pressing step and is arranged between the cathode layer and the anode layer, at a second pressure smaller than the first pressure.

Here, the expression “before arranging the solid electrolyte between the cathode layer and the anode layer” means: (1) after layering the solid electrolyte layer and the anode layer having the same size as the solid electrolyte layer, such that each lateral side aligns in a layering direction, and before making the solid electrolyte have contact with the cathode layer; (2) after layering the solid electrolyte layer and the cathode layer having the same size as the solid electrolyte layer, such that each lateral side aligns in a layering direction, and before making the solid electrolyte layer have contact with the anode layer; or (3) before making the solid electrolyte layer have contact with the cathode layer, and before making the solid electrolyte layer have contact with the anode layer (in this case, the magnitude relation of the solid electrolyte layer, the cathode layer, and the anode layer is not particularly limited). By pressing the solid electrolyte layer at the first pressure, it becomes possible to make the thickness of the solid electrolyte layer thin, and even though the solid electrolyte before pressing has holes that pass through the solid electrolyte layer in the thickness direction, it becomes possible to occlude the holes. By having a configuration in which a solid electrolyte layer not having any holes that pass through the solid electrolyte layer in a thickness direction is provided, it is possible to inhibit a short circuit. Also, after pressing the solid electrolyte layer at the first pressure, by arranging the solid electrolyte layer between the cathode layer and the anode layer then pressing them at the second pressure smaller than the first pressure, it is possible to prevent a situation in which the solid electrolyte layer breaks in the second pressing step. Therefore, with this configuration, it is possible to prevent a situation in which the cathode layer and the anode layer are electrically conducted to each other via the active material entered the holes or broken portion of the solid electrolyte layer, whereby it is possible to prevent a short circuit.

Also, in the first aspect of the present invention, it is preferable that the solid electrolyte layer includes a solid electrolyte powder; and the solid electrolyte layer has a filling factor of the solid electrolyte powder contained in the solid electrolyte layer of no less than 80% before the solid electrolyte layer is pressed in the second pressing step.

Here, the expression “filling factor of the solid electrolyte powder is no less than 80%” means that a space occupancy rate of the solid electrolyte in the solid electrolyte layer is no less than 80%. The space occupancy rate is identified by excluding space existing around the solid electrolyte and can be identified by carrying out an image analysis of a cross section of the solid electrolyte layer. By having 80% of the space occupancy rate of the solid electrolyte in the solid electrolyte layer before the solid electrolyte layer is pressed in the second pressing step, it becomes easy to inhibit a short circuit.

Also, in the first aspect of the present invention in which the solid electrolyte layer contains the solid electrolyte powder, it is preferable that the average particle diameter D50 of the solid electrolyte powder and/or the thickness of the solid electrolyte layer are adjusted such that X/Y≦1/4, wherein X is the average particle diameter D50 of the solid electrolyte powder, and Y is the thickness of the solid electrolyte layer after the second pressing step.

Here, the expression “the average particle diameter D50 of the sulfide solid electrolyte powder is adjusted such that X/Y≦1/4” means, for example, that in a case where the thickness of the solid electrolyte layer is determined before manufacturing the all-solid-state battery, the solid electrolyte layer is made with a solid electrolyte powder having an average particle diameter D50 which satisfies X/Y≦1/4. Also, the expression “the thickness of the solid electrolyte layer is adjusted such that X/Y≦1/4” means, for example, that in a case where the particle diameter D50 of the solid electrolyte powder to be used for manufacturing the all-solid-state battery is determined, the production conditions and pressing conditions of the solid electrolyte layer are adjusted such that the thickness of the solid electrolyte layer satisfies X/Y≦1/4. By adjusting either one or both of the average particle diameter D50 of the solid electrolyte and the thickness of the solid electrolyte layer, it becomes easy to inhibit a short circuit.

Also, in the first aspect of the present invention in which the solid electrolyte layer contains a solid electrolyte powder, it is preferable that the solid electrolyte includes a binder. By using a binder with the solid electrolyte powder, it becomes easy to evenly arrange the solid electrolyte powder in the solid electrolyte layer, whereby it becomes easy to inhibit a short circuit.

### Effects of the Invention

According to the present invention, it is possible to provide a method for manufacturing an all-solid-state battery capable of inhibiting a short circuit.

### BRIEF DESCRIPTION OF THE DRAWINGS

FIG. 1 is a flowchart to explain the method for manufacturing an all-solid-state battery of the present invention;

FIG. 2 is a view to explain the method for manufacturing an all-solid-state battery of the present invention;

FIG. 3 is a graph to show performance evaluation results of all-solid-state batteries.

### DETAILED DESCRIPTION OF THE INVENTION

Hereinafter, the present invention will be described with reference to the drawings. It should be noted that the embodiments shown below are examples of the present invention, and the present invention is not limited to the embodiments.

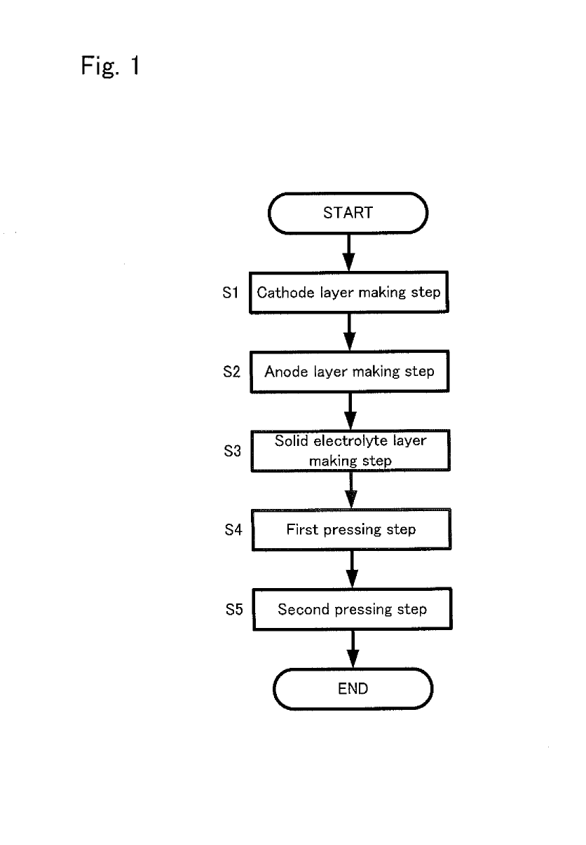

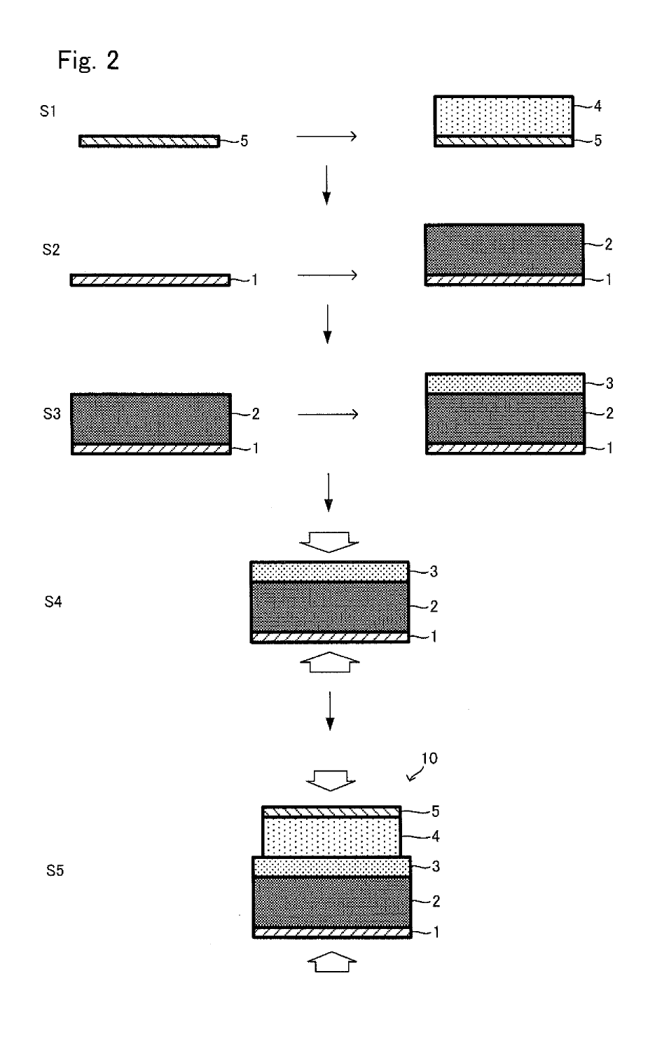

FIG. 1 is a flowchart to explain the present invention, and FIG. 2 is a view to explain one embodiment of the present invention. Hereinafter, one embodiment of the present invention will be described with reference to the FIGS. 1 and 2.

As shown in FIG. 1, the present invention includes a cathode layer making step S1, an anode layer making step S2, a solid electrolyte layer making step S3, a first pressing step S4, and a second pressing step S5.

The cathode layer making step S1 is a step of making the cathode layer to be provided to the all-solid-state battery. In the present invention, the configuration of the cathode layer making step S1 is not particularly limited as long as the cathode layer to be provided to the all-solid-state battery can be made. A known method can be applied to the step of making the cathode layer. For example the cathode layer making step S1 may be a step of making a cathode layer 4 on a surface of the cathode current collector 5, by going through the process of: applying a cathode composition in a slurry form to the surface of the cathode current collector 5 by means of a wet process such as a doctor blade method, the cathode composition being produced by adding a cathode active material, a solid electrolyte powder, a binder, and a conductive material to a nonpolar solvent and mixing them; and drying the resultant material.

The anode layer making step S2 is a step of making an anode layer to be provided to the all-solid-state battery. In the present invention, the configuration of the anode layer making step S2 is not particularly limited as long as the anode layer to be provided to the all-solid-state battery can be made. A known method can be applied to the step of making the anode layer. For example the anode layer making step S2 can be a step of manufacturing an anode layer 2 on a surface of the anode current corrector 1 by going through the process of: applying an anode composition in a slurry form to the surface of the anode current collector 1 by means of a wet process such as a doctor blade method, the anode composition being produced by adding an anode active material, a solid electrolyte powder, and a binder to a nonpolar solvent and mixing them; and drying the resultant material.

The solid electrolyte layer making step S3 is a step of making a solid electrolyte layer to be provided to the all-solid-state battery. In the present invention, the configuration of the solid electrolyte layer making step S3 is not particularly limited as long as the solid electrolyte layer can be made. A known method can be applied to the step of making the solid electrolyte layer. For example the solid electrolyte layer making step S3 may be a step of making a solid electrolyte layer 3 on a surface of the anode layer 2 by going through the process of: applying an electrolyte composition in a slurry form to a surface of the anode layer 2 by means of a wet process such as a doctor blade method, the electrolyte composition being produced by adding a solid electrolyte powder and a binder to a nonpolar solvent and mixing them; and drying the resultant material.

The first pressing step S4 is a step of pressing the solid electrolyte layer at the first pressure which is larger than the second pressure in the second pressing step described below, before arranging the solid electrolyte layer between the cathode layer and the anode layer. The configuration of the first pressing step S4 is not particularly limited as long as the solid electrolyte layer can be pressed at the first pressure before the solid electrolyte layer is arranged between the cathode layer and the anode layer (for example, before the solid electrolyte layer is sandwiched by the cathode layer and the anode layer). For example the first pressing step S4 may be a step of pressing the solid electrolyte layer 3 with the anode layer 2 at the first pressure, such that the solid electrolyte powder contained in the solid electrolyte layer 3 made on the surface of the anode layer 2 has a filling factor of no less than 80%, and such that X/Y≦1/4 wherein X is the average particle diameter D50 of the solid electrolyte powder and Y is the thickness of the solid electrolyte layer 3 after the second pressing step which is described later. In the present invention, the first pressure is not particularly limited as long as the pressure can occlude the holes passing through the solid electrolyte layer in the thickness direction. In view of having the pressure which can occlude the holes, the minimum value of the first pressure is preferably no less than 200 MPa. A more preferable minimum value of the first pressure is no less than 400 MPa. The maximum value of the first pressure is not limited, and in view of inhibiting a mixture of the electrode layer (the cathode layer or the anode layer) from coming out from the edge of the electrode layer, in pressing the solid electrolyte layer and the electrode layer having contact with each other, preferably no more than 1000 MPa for example. More preferably, the maximum value of the first pressure is no more than 800 MPa.

The second pressing step S5 is a step of pressing the solid electrolyte layer which has been pressed in the first step and is arranged between the cathode layer made in the cathode layer making step S1 and the anode layer made in the anode layer making step S2, at the second pressure smaller than the first pressure. For example the second pressing step S5 can be a step of pressing the solid electrode layer 3 with the cathode layer 4 made on the surface of the cathode current collector 5 arranged on the opposite side of the solid electrolyte layer 3 from the anode layer 2, at the second pressure smaller than the first pressure. In the present invention, the second pressure is not particularly limited as long as the second pressure is smaller than the first pressure. However, in view of tightly adhering the cathode layer and the anode layer that are to have contact with the solid electrolyte layer in the second pressing step, and the solid electrolyte layer, to such a degree that the ion conductivity resistance can be reduced, it is preferable that the minimum value of the second pressure is no less than 200 MPa. A more preferable minimum value of the second pressure is no less than 400 MPa. The maximum value of the second pressure is not particularly limited as long as the second pressure is smaller than the first pressure, and in view of inhibiting the mixture of the electrode layers (the cathode layer and the anode layer) from coming out from the edge of the electrode layer in pressing the solid electrolyte layer and the electrode layer, preferably no more than 1000 MPa for example.

By pressing the solid electrolyte layer at the first pressure, it is possible to thinly make the solid electrolyte layer 3, and in addition, even though the solid electrolyte layer 3 before pressing has holes that pass through the solid electrolyte layer 3 in the thickness direction, it is possible to occlude the holes. By having a configuration in which the solid electrolyte 3 which does not have any holes passing through the solid electrolyte layer 3 in the thickness direction is provided, it is possible to inhibit a short circuit. Also, the solid electrolyte layer 3 pressed at the first pressure is compacted. Therefore, it is possible to prevent a situation of breaking the periphery and the like of the solid electrolyte layer 3 where the pressure concentrates, even though the solid electrolyte layer 3 is pressed at the second pressure with a state of being arranged between the cathode layer 4 and the anode layer 2 that are smaller than the solid electrolyte 3. Therefore, this configuration makes it possible to prevent a situation in which the cathode layer 4 and the anode layer 2 are electrically conducted to each other via the active materials entered the holes and broken portion of the solid electrolyte layer 3, whereby it is possible to manufacture the all-solid-state battery 10 capable of inhibiting a short circuit.

In the above explanation regarding the present invention, the configuration in which the filling factor of the solid electrolyte powder contained in the solid electrolyte layer 3 is no less than 80% when the solid electrolyte layer 3 is pressed in the second pressing step S5 is exemplified. However, the present invention is not limited to this configuration. The filling factor of the solid electrolyte powder may be less than 80%. However, in view of having a configuration in which the all-solid-state battery which can easily inhibit a short circuit can be manufactured, it is preferable that the solid electrolyte layer is pressed in the first pressing step such that the filling factor of the solid electrolyte powder contained in the solid electrolyte layer is no less than 80%, before the solid electrolyte layer is pressed in the second pressing step.

Also, in the above explanation regarding the present invention, the configuration in which pressing is carried out in the first pressing step such that X/Y≦1/4, wherein X is the average particle diameter D50 of the solid electrolyte powder, and Y is the thickness of the solid electrolyte layer after the second pressing step is exemplified. However, the present invention is not limited to this configuration. The average particle diameter D50 of the solid electrolyte powder and the thickness of the solid electrolyte layer after the second pressing step may be X/Y>1/4. However, in view of having a configuration in which the all-solid-state battery which can easily inhibit a short circuit, it is preferable that the average particle diameter D50 of the solid electrolyte powder and/or the thickness of the solid electrolyte layer 3 are adjusted such that X/Y≦1/4.

Also, in the above explanation regarding the present invention, the configuration in which a binder is used with the solid electrolyte powder is exemplified. However, the present invention is not limited to this configuration. The present invention can have a configuration in which a binder is not used even though the solid electrolyte powder is used. However, in view of having a configuration in which a short circuit is easily inhibited, it is preferable that the solid electrolyte layer is made with a binder, in a case where the solid electrolyte powder is used.

In the present invention, the solid electrolyte to be contained in the solid electrolyte layer is not particularly limited, and a known solid electrolyte which can be used for the all-solid-state battery can be used. Examples of the solid electrolyte include: oxide-based amorphous solid electrolytes such as Li₂O—B₂O₃—P₂O₅ and Li₂O—SiO₂; sulfide-based amorphous solid electrolytes such as Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, and Li₃P₂S₄; crystalline oxides and crystalline oxynitrides such as LiI, Li₃N, Li₅La₃Ta₂O₁₂, Li₇La₃Zr₂O₁₂, Li₆BaLa₂Ta₂O₁₂, Li₃PO_{(4-3/2w)}N_{w} (w<l), and Li_{3.6}Si_{0.6}P_{0.4}O₄; known halides and the like. However, in view of having a configuration in which an electrode for solid battery which can easily improve the performance of the solid battery can be manufactured and the like, it is preferable to use a sulfide solid electrolyte for the solid electrolyte. The solid electrolyte used for the present invention may be crystalline, amorphous, or a glass ceramics.

Also, in the present invention, in a case where the solid electrolyte powder is used for the solid electrolyte, its average particle diameter D50 is not particularly limited. However, in view of having a configuration in which a short circuit is easily inhibited, it is preferable that X/Y≦1/4 wherein X is the average particle diameter D50 of the solid electrolyte and Y is the thickness of the solid electrolyte layer.

Also, as described above, in the present invention, the solid electrolyte layer can contain a binder, and a known binder which can be used for the solid electrolyte layer of the all-solid-state battery can be adequately used. Examples of the binder include acrylonitrile butadiene rubber (NBR), butadiene rubber (BR), polyvinylidene fluoride (PVdF), styrene butadiene rubber (SBR) and the like. In view of making it possible to form the solid electrolyte layer including the solid electrolyte evenly dispersed and prevented from an excessive aggregation in order to easily realize a high output and the like, in a case where the binder is contained in the solid electrolyte layer, the amount of the binder is preferably no more than 5% by mass. Also, in a case where the solid electrolyte layer is made by going through a step of applying a solid electrolyte composition in a slurry form adjusted by dispersing the solid electrolyte powder and the binder to a liquid, as the liquid to disperse the solid electrolyte powder and the binder, heptane and the like can be exemplified, and a monopolar solvent can be preferably used. The content of the solid electrolyte in the solid electrolyte layer is, by mass %, for example preferably no less than 60%, more preferably no less than 70%, and especially preferably no less than 80%. The thickness of the solid electrolyte layer may be, largely depending on the structure of the battery, for example no less than 5 μm and no more than 30 μm.

As the cathode active material to be contained in the cathode layer, a known cathode active material which can be used for an all-solid-state battery may be adequately used. Examples of the cathode active material include: layer type active materials such as lithium cobalt oxide (LiCoO₂) and lithium nickelate (LiNiO₂); olivine type active materials such as olivine type iron phosphate lithium (LiFePO₄), spinel type active materials such as spinel type lithium manganate (LiMn₂O₄) and the like. The cathode active material can be formed in a particle for example. The average particle diameter (D50) of the cathode active material is, for example preferably no less than 1 nm and no more than 100 μm, more preferably no less than 10 nm and no more than 30 μm. The content of the cathode active material in the cathode layer is not particularly limited, and for example no less than 40% and no more than 99% by mass %.

In the present invention, if necessary, not only the solid electrolyte layer but also the cathode layer can contain a known solid electrolyte which can be used for an all-solid-state battery. Examples of the solid electrolyte include the above solid electrolytes that can be contained in the solid electrolyte layer. In a case where the cathode layer contains the solid electrolyte, the mixing ratio of the cathode active material and the solid electrolyte is not particularly limited.

In a case where the cathode layer contains a sulfide solid electrolyte, in view of having a configuration in which a high resistance layer is difficult to be formed at the interface between the cathode active material and the sulfide solid electrolyte to thereby prevent increase in the battery resistance, it is preferable that the cathode active material is covered by an ion conductive oxide. Examples of a lithium ion conductive oxide to cover the cathode active material include oxides represented by the general formula LiₓAO_{y} (A is B, C, Al, Si, P, S, Ti, Zr, Nb, Mo, Ta, or W; x and y are positive numbers). Specifically, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄ and the like may be exemplified. The lithium ion conductive oxide may be a composite oxide. For the composite oxide to cover the cathode active material, the above-described lithium ion conductive oxides may be adequately combined. For example, Li₄SiO₄—Li₃BO₃, Li₄SiO₄—Li₃PO₄ and the like may be given. In a case where the surface of the cathode active material is covered by the ion conductive oxide, it is only necessary that the ion conductive oxide covers at least a part of the cathode active material, and the ion conductive oxide may cover the whole surface of the cathode active material. The thickness of the ion conductive oxide to cover the cathode active material is, for example preferably no less than 0.1 nm and no more than 100 nm, and more preferably no less than 1 nm and no more than 20 nm. The thickness of the ion conductive oxide can be measured by means of a transmission type electron microscope (TEM) and the like for example.

Also, a known binder which can be contained in the cathode layer of an all-solid-state battery can be used for the cathode layer. As the binder, the above-described binders that can be contained in the solid electrolyte layer may be exemplified.

Further, the cathode layer may contain a conductive material which improves conductivity. Examples of the conductive material which can be contained in the cathode layer include carbon materials such as vapor growth carbon fiber, acetylene black (AB), Ketjen black (KB), carbon nanotube (CNT), and carbon nanofiber (CNF), and metal materials that can endure the environment in use of the all-solid-state battery. Also, for example in a case where the cathode layer is made with the cathode composition in a slurry form adjusted by dispersing the cathode active material, the solid electrolyte, the binder and the like to a liquid, heptane can be exemplified as the liquid which can be used, and a nonpolar solvent is preferably used. The making method of the cathode layer is not particularly limited. For example, as the method for making the cathode layer prepared with the cathode composition, wet processes such as a doctor blade method, a die coat method, a gravure method can be given. The thickness of the cathode layer is for example preferably no less than 0.1 μm and no more than 1 mm, and more preferably no less than 1 μm and no more than 100 μm. In order to make it easy to improve the performance of the all-solid-state battery, it is preferable that the cathode layer is made by going through a process of pressing. In the present invention, the pressure to press the cathode layer may be approximately 400 MPa.

As the anode active material to be contained in the anode layer, a known anode active material which can be used for the all-solid-state battery may be adequately used. Examples of the anode active material include carbon active materials, oxide active materials, metal active materials and the like. The carbon active materials are not particularly limited as long as they contain carbon, and for example natural graphite, mesocarbon microbeads (MCMB), highly oriented graphite (HOPG), hard carbons, soft carbons and the like can be given. As the oxide active materials, for example Nb₂O₅, Li₄Ti₅O₁₂, SiO and the like can be given. As the metal active materials, for example In, Al, Si, Sn and the like can be given. Also, as the anode active material, a lithium-containing metal active material may be used. The lithium-containing metal active material is not particularly limited, and it may be a Li metal, or a Li alloy. As the Li alloy, an alloy containing Li and at least one kind selected from In, Al, Si, and Sn can be given. The anode active material can be formed in a particle for example. The average particle diameter (D50) of the anode active material is, for example preferably no less than 1 nm and no more than 100 μm, and more preferably no less than 10 nm and no more than 30 μm. The content of the anode active material in the anode layer is not particularly limited, and for example no less than 40% and no more than 99% by mass %.

Further, the anode layer can contain the solid electrolyte, and it can also contain a binder to bind the anode active material and the solid electrolyte, and a conductive material to improve conductivity. In a case where the anode layer contains the solid electrolyte, the mixing ratio of the anode active material and the sulfide solid electrolyte is not particularly limited. As the solid electrolyte, the binder, and the conductive material that can be contained in the anode layer, the above described solid electrolyte, binder, conductive material and the like that can be contained in the cathode layer can be exemplified. In a case where the anode layer is made with an anode composition in a slurry form adjusted by dispersing the above-described anode active material and the like to a liquid, as the liquid to disperse the anode active material and the like, heptane can be exemplified, and a nonpolar solvent can be preferably used. The making method of the anode layer is not particularly limited. The anode layer can be made by means of a same method as the making method of the cathode layer for example. The thickness of the anode layer is for example preferably no less than 0.1 μm and no more than 1 mm, and more preferably no less than 1 μm and no more than 100 μm. In order to make it easy to improve the performance of the all-solid-state battery, the anode layer is preferably made by going through a process of pressing. In the present invention, the pressure to press the anode layer is preferably no less than 200 MPa, and more preferably approximately 400 MPa.

As a cathode current collector connected to the cathode layer and an anode current collector connected to the anode layer, a known metal which can be used for the current collector of an all-solid-state battery can be adequately used. Examples of the metal include a metal material including one or two or more elements selected from the group consisting of Cu, Ni, Al, V, Au, Pt, Mg, Fe, Ti, Co, Cr, Zn, Ge, and In.

As a housing to wrap the all-solid-state battery manufactured by means of the present invention, a known laminate film which can be used for an all-solid-state battery and the like can be used. Examples of the laminate film include a laminate film made of resin, a film in which a metal is evaporated to a laminate film made of resin and the like.

In the above explanation regarding the present invention, the configuration in which the cathode layer making step S1 is followed by the anode layer making step S2 is exemplified. However, the present invention is not limited to this configuration. The present invention can have a configuration in which the anode layer making step is followed by the cathode layer making step.

Also, in the above explanation regarding the present invention, the configuration in which the all-solid-state battery is a lithium-ion secondary battery is exemplified. However, the present invention is not limited to this configuration. The all-solid-state battery made by means of the present invention can have a configuration in which ions other than lithium ions transfer between the cathode layer and the anode layer. Examples of such ions include sodium ions, magnesium ions and the like. In a case where ions other than lithium ions transfer, the cathode active material, the solid electrolyte, and the anode active material can be accordingly chosen depending on the ions to transfer.

### EXAMPLES

### Sample Preparation

### Example 1

1) Cathode Layer

A cathode active material (LiNi_{1/3}Co_{1/3}Mn_{1/3}O₂), a solid electrolyte (75Li₂S-25P₂S₅. The same is applied hereinafter), a conductive material (vapor growth carbon fiber, manufactured by SHOWA DENKO K.K.), and a binder (butylenes rubber, manufactured by JSR Corporation. The same is applied hereinafter) were weighed such that their weight ratio was cathode active material:solid electrolyte:conductive material:binder=100:33.5:3:1.5, and mixed, whereby a cathode mixture was made.

In inert gas (argon gas. The same is applied hereinafter), a cathode composition in a slurry form was made by mixing the cathode mixture and a solvent (heptane, manufactured by KANTO CHEMICAL CO., INC. The same is applied hereinafter). The obtained cathode composition was applied to a cathode current collector (aluminum foil) by means of a doctor blade method, then dried, whereby a cathode layer was made on the cathode current collector.

2) Anode Layer

An anode active material (natural carbon), the solid electrolyte, and the binder were weighed such that their weight ratio was anode active material:solid electrolyte:binder=100:73:1.1, and mixed, whereby an anode mixture was produced.

In inert gas, an anode composition in a slurry form was produced by mixing the anode mixture and a solvent. The anode composition was applied to an anode current collector (copper foil) by means of a doctor blade method, then dried, thereby an anode layer was made on the anode current collector.

3) Solid Electrolyte Layer

The solid electrolyte and the binder were weighed such that their weight ratio was solid electrolyte:binder=100:1, and mixed, whereby an electrolyte material was produced. As the solid electrolyte, a solid electrolyte powder having an average particle diameter D50 of 2.5 μm was used.

In inert gas, an electrolyte composition in a slurry form was made by mixing the electrolyte material and a solvent. The electrolyte composition was applied to a base material (aluminum foil) by means of a doctor blade method and dried, whereby a solid electrolyte layer was made on the base material.

4) Production of all-Solid-State Battery

In inert gas, the anode layer and the solid electrolyte layer were punched out in a size of 1.33 cm², and pressed at a pressure of 441 MPa in a state of being overlapped with each other so as to have contact with each other. Thereafter the base material in contact with the solid electrolyte layer was peeled, whereby the solid electrolyte layer was arranged (transferred) on a surface of the anode layer. At this time, the filling factor of the solid electrolyte in the solid electrolyte layer was 80%. Next, the cathode layer was punched out in a size of 1 cm², and pressed at a pressure of 421 MPa in a state of being layered with the solid electrolyte layer arranged on the surface of the anode layer, such that the solid electrolyte layer and the cathode layer have contact with each other, whereby an all-solid-state battery (the all-solid-state battery of Example 1) was made. The thickness of the solid electrolyte layer provided to the all-solid-state battery of Example 1 was 20 μm.

### Example 2

An all-solid-state battery of Example 2 was made in the same manner as in making the all-solid-state battery of Example 2, except that the solid electrolyte layer provided to the all-solid-state battery had a thickness of 10 μm. In the all-solid-state battery of Example 2 as well, the filling factor of the solid electrolyte in the solid electrolyte layer before having contact with the cathode layer was 80%.

### Example 3

An all-solid-state battery of Example 3 was made in the same manner as in making the all-solid-state battery of Example 1, except that the electrolyte composition was applied by means of a doctor blade method to the surface of the anode layer made on the anode current collector and dried, whereby the solid electrolyte layer was made on the surface of the anode layer. In the all-solid-state battery of Example 3 as well, the filling factor of the solid electrolyte in the solid electrolyte layer before having contact with the cathode layer was 80%.

### Comparative Example

In inert gas, the anode layer and the solid electrolyte layer were punched out in a size of 1 cm², and pressed at a pressure of 98 MPa in a state of being overlapped with each other so as to have contact with each other. Thereafter the base material in contact with the solid electrolyte layer was peeled, whereby the solid electrolyte layer was arranged (transferred) on a surface of the anode layer. At this time, the filling factor of the solid electrolyte in the solid electrolyte layer was 67%. Next, the cathode layer was punched out in a size of 1 cm², and pressed at a pressure of 421 MPa in a state of being layered with the solid electrolyte layer arranged on the surface of the anode layer such that the solid electrolyte layer and the cathode layer have contact with each other, whereby an all-solid-state battery of Comparative Example was made. The thickness of the solid electrolyte layer provided to the all-solid-state battery of Comparative Example was 30 μm.

<Performance Evaluation>

The all-solid-state batteries of Examples 1, 2, and 3 (hereinafter sometimes the batteries are collectively referred to as “the all-solid-state batteries of Examples”) and the all-solid-state battery of Comparative Example were pressed at a pressure of 44.1 MPa in inert gas, thereafter put in an airproof container to evaluate the performance of the batteries. Each all-solid-state battery was subjected to 1 cycle of charging and discharging at 0.1 C rate, constant current, and voltage (constant voltage end condition: 1/200 C) having a voltage range from 4.2V to 2.5V. Thereafter the all-solid-state battery was charged to reach 4.2V at 0.1 C rate and constant current. The performance evaluation of the battery was carried out by examining whether the voltage was maintained or not after the battery was left for 24 hours.

<Result>

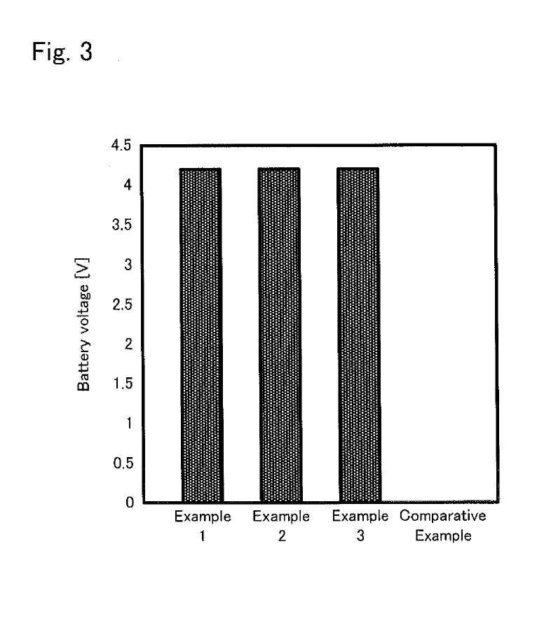

The performance evaluation results are shown in FIG. 3. As shown in FIG. 3, each of the all-solid-state batteries of Examples had a voltage of 4.2V, which means the voltage was maintained. However, the voltage of the all-solid-state battery of Comparative Example was 0V, which means the voltage was not maintained. That is, even though the solid electrolyte layer was made to be thicker than that of the all-solid-state batteries of Examples, an internal short circuit of battery was occurred in the all-solid-state battery of Comparative Example in which the solid electrolyte layer was not pressed at the maximum pressure of the manufacturing step, before arranging the solid electrolyte layer between the cathode layer and the anode layer. In contrast, it was possible to prevent a short circuit in the all-solid-state batteries of Examples in which the solid electrolyte layer was pressed at the maximum pressure of the manufacturing step before arranging the solid electrolyte layer between the cathode layer and the anode layer. From the above results, it was shown that, according to the present invention, it is possible to prevent a short circuit even if the solid electrolyte layer is thinly made in order to reduce the resistance.

### DESCRIPTION OF THE REFERENCE NUMERALS

1 anode current collector
2 anode layer
3 solid electrolyte layer
4 cathode layer
5 cathode current collector
10 all-solid-state battery

1. A method for manufacturing an all-solid-state battery comprising a cathode layer, an anode layer, and a solid electrolyte layer arranged between the cathode layer and the anode layer, the method comprising:
a first pressing step of pressing the solid electrolyte layer at a first pressure before arranging the solid electrolyte layer between the cathode layer and the anode layer, and
a second pressing step of pressing the solid electrolyte layer which has been pressed in the first pressing step and is arranged between the cathode layer and the anode layer, at a second pressure smaller than the first pressure,
wherein the second pressure is no less than 400 MPa.

2. The method for manufacturing an all-solid-state battery according to claim 1,
wherein the solid electrolyte layer comprises a solid electrolyte powder; and
the solid electrolyte layer has a filling factor of the solid electrolyte powder contained in the solid electrolyte layer of no less than 80% before the solid electrolyte layer is pressed in the second pressing step.

3. The method for manufacturing an all-solid-state battery according to claim 2,
wherein the average particle diameter D50 of the solid electrolyte powder and/or the thickness of the solid electrolyte layer are adjusted such that
X/Y≦1/4
wherein X is the average particle diameter D50 of the solid electrolyte powder, and Y is the thickness of the solid electrolyte layer after the second pressing step.

4. The method for manufacturing an all-solid-state battery according to claim 2,
wherein the solid electrolyte battery comprises a binder.
